(19) United States
(12) Patent Application Publication
(10) Pub. No.: US 2009/0127810 A1
(43) Pub. Date: May 21, 2009

(54) Stroller Assembly and Handle

(75) Inventors: Michael A. Dotsey, Pottstown, PA (US); Joseph T. Grintz, Glenmoore, PA (US); Roy Lucas Dean, Pottstown, PA (US); Thomas Perrin, Downingtown, PA (US)

Correspondence Address: LEMPIA BRAIDWOOD LLC, 223 W. JACKSON BLVD., SUITE 620, CHICAGO, IL, 60606, US

(73) Assignee: Graco Children's Products Inc., Exton, PA (US)

(21) Appl. No.: 12/272,598

(22) Filed: Nov. 17, 2008

Related U.S. Application Data
(60) Provisional application No. 60/988,635, filed on Nov. 16, 2007.

(51) Int. Cl. B62B 7/00

(52) U.S. Cl. 280/47.371; 280/47.38

(57) ABSTRACT

A stroller assembly has a frame assembly with a front and a back. The stroller assembly also has a handle coupled to the frame assembly and positioned near the back of the frame assembly. The handle has a central section between a pair of side sections and the side sections extending further rearward than the central section relative to the back of the frame assembly.

### RELATED APPLICATION DATA

This patent is related to and claims priority benefit of U.S. provisional patent application Ser. No. 60/988,635, which was entitled “Strollers with Parent/Child Contact Features” and which was filed on Nov. 16, 2007. The entire contents of this prior filed provisional application are incorporated herein by reference.

### BACKGROUND OF THE INVENTION

1. Field of the Disclosure

The present disclosure is generally directed to strollers, and more particularly to a stroller assembly and handle configuration that achieves better ergonomics for the caregiver and allows for closer proximity between caregiver and child during use of the stroller.

2. Description of Related Art

Most existing stroller models have a toddler seat provided as part of the stroller. A number of existing strollers are also configured to mount an infant car sear or infant carrier on the stroller over the toddler seat. Such strollers can thus be configured to transport a newborn or an infant child, prior to the child growing to a size for which the stroller's toddler seat is suited. A typical stroller assembly is configured in such a way that the infant carrier can be mounted closely spaced above the toddler seat, which is a relatively low position. This infant carrier mounting arrangement does not hamper or significantly alter the stability of the stroller during use. However, this mounting arrangement results in a sizeable distance between the parent or caregiver pushing the stroller and the child seated in the infant carrier (see FIG. 7). This relatively large distance and overall cumbersome arrangement makes interaction between the child and parent or caregiver more difficult.

In addition, a typical stroller handle assembly has a linear cross bar or a rearwardly bowed cross bar that extends laterally between the sides of the stroller and well behind the toddler seat. The typical handle design requires the caregiver to stand quite far rearward behind the stroller during use. The handle also creates a barrier, which can prevent the parent or caregiver from reaching or leaning forward closer to the infant in the carrier. The low mounting position of the typical infant carrier, in combination with the conventional handle location and shape, tends to barricade the infant from the parent. The arrangement, often coupled with a stroller's toddler seat canopy and soft goods, can inhibit or even prevent the caregiver from physically reaching or making eye contact with the infant seated in the carrier while pushing the stroller.

It is well known that direct eye contact between an infant and caregiver can be calming, comforting, and soothing to the infant. A young infant typically can not see very clearly beyond about 12 to 18 inches. Because of the lengthy distance, it can be difficult for an infant to recognize the caregiver while seated in the infant carrier during use of these known strollers. Direct eye contact between caregiver and infant at lengthier distances would not be very beneficial or helpful. It is also well known that direct physical contact between caregiver and infant can often be of significant benefit to the infant or even necessary. For instance, a caregiver's simple touch can be quite calming, comforting, and soothing to the infant. A caregiver may need to readjust the infant's seating position or the position of a seat harness. The caregiver may need to reposition a blanket over the infant or replace to reinsert a fallen pacifier. Any number of circumstances may require frequent direct physical contact between caregiver and infant.

Prior known stroller systems or travel systems significantly hinder the ability of the caregiver to make direct eye contact or to readily reach out and touch the infant. To overcome these difficulties, the caregiver must stop the stroller and walk around to the side of the stroller. For added safety, the caregiver often will also then apply the stroller brake. In addition, the caregiver must also typically bend or lean down in order to comfortably reach the infant or make adequate eye contact.

Others have attempted to solve or improve upon these disadvantages with conventional strollers. One such attempt involved raising the seat higher on the stroller frame. A Stokke stroller product, known as the Stokke Xplory stroller, provided a height adjustable mounting position for the stroller seat or an infant carrier. However, this stroller employed a completely unique stroller frame design. This Stokke stroller design was based on a frame with a single vertical spar with a seat assembly that slid up or down the spar. The stroller would be quite top heavy and thus unstable with the seat and seat occupant in the raised position. The seat would also not be supported in a particularly stable manner, with only one end of the seat mounted only to the vertical spar of the frame. The location of the central frame spar also would result in a seat occupant not being able to place their feet together. Such placement would be hindered by the central location of the spar. Small children are often much more comfortable with their feet together of even crossed. In addition, the Stokke stroller included a handle design that essentially moved the caregiver even further rearward away from the child. The Stokke Xplory stroller might have resulted in some improved interaction between caregiver and child by raising the seat height. However, this solution added to the barrier problem created by the handle design and did not address removing or modifying any other physical obstacles on the stroller, such as the canopy and soft goods arrangement located between the caregiver and the child seat occupant. In addition, stability of the seat and frame arrangement of the Stokke stroller is suspect and the comfort of the child seat occupant is negatively affected. In addition, the seat is the only seat on the stroller frame. If the seat is an infant seat, the stroller is not configured to hold a toddler unless the seat is entirely removed and replaced with a different toddler seat.

Other attempts have also been made to address these problems and disadvantages with maintaining the parent and child relationship during use of conventional strollers. For example, several stroller products are known to employ a rotatable or reversible handle, a reversible canopy, a movable canopy flap, or a reversible infant carrier mounting arrangement to help reduce the physical barrier and/or to create closer contact or a more direct visual connection between the caregiver and child. These conventional solutions have proved unsatisfactory. The Stokke Xplory stroller discussed above is one rare existing example that attempts to employ alternative solutions to these more common methods.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a stroller assembly constructed in accordance with the teachings of the present invention.

FIG. 2 shows a side view of the stroller assembly shown in FIG. 1.

FIG. 3 shows a partially exploded view of the stroller assembly in FIG. 2 with the infant carrier detached from the stroller.

FIG. 4 shows a top view of the handle bar on the stroller assembly in FIG. 1.

FIG. 5 shows a side view of the stroller assembly in FIG. 1 with a caregiver positioned rearward of the handle bar and pushing the stroller.

FIG. 6 shows the stroller assembly in FIG. 5 with the caregiver standing directly behind and against the handle bar for close interaction with the child occupant of the infant carrier.

FIG. 7 shows a prior art stroller assembly with an infant carrier mounted to the toddler seat and accessory tray.

### DETAILED DESCRIPTION OF THE DISCLOSURE

The disclosed stroller assembly solves or improves upon one or more of the above noted and/or other problems and disadvantages with conventional strollers. In one example, the disclosed stroller assembly provides a handle configuration that reduces or removes any barrier between the caregiver and child. Instead, the disclosed stroller assembly permits the caregiver to step up closer to the child seated in the infant carrier mounted to the stroller. In another example, the disclosed stroller assembly allows for mounting an infant carrier on the stroller frame in a raised position closer to the caregiver. The combination of the handle configuration and the raised carrier mounting position results in the stroller assembly maintaining adequate stability while achieving vastly improved caregiver and child contact and interaction during use of the stroller.

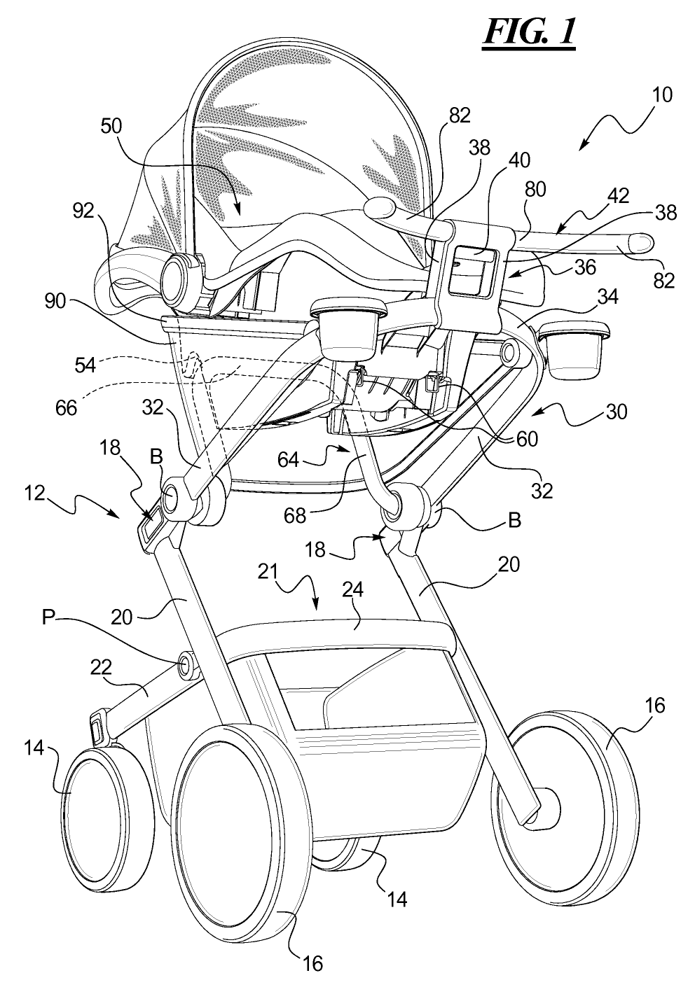

Turning now to the drawings, FIG. 1 shows a prospective view of a stroller assembly 10 constructed in accordance with the teachings of the present invention. The disclosed stroller assembly 10 utilizes but one of many alternate stroller frame configurations and constructions that could be employed within the spirit and scope of the present invention. In the disclosed example, the stroller assembly 10 has a frame assembly 12 supported by a pair of front wheels 14 and a pair of rear wheels 16 as is generally known in the art. In this example, the frame assembly 12 has a pair of opposed sides, each with a pivotable fold joint 18 connecting components of the frame assembly. Each frame side in this example has a rear leg 20 extending down from the corresponding fold joint 18 on the respective side. A lower end of each rear leg 20 is coupled to one of the rear wheels 16 in a conventional manner. In this example, a U-shaped front leg tube assembly 21 has a pair of front legs 22. Each front leg 22 extends forward and terminates at a lower end attached to one of the front wheels 14 in a conventional manner. The U-shaped front leg tube 21 also includes a cross bar 24 interconnecting the opposite upper ends of the two front legs 22.

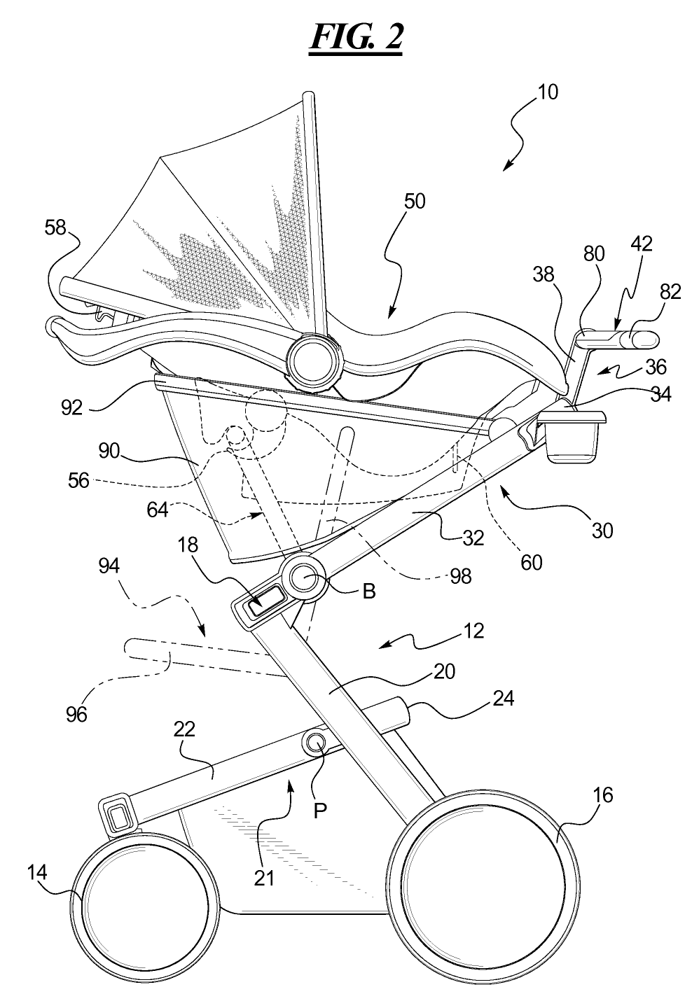

The leg tube 21 is pivotally coupled to the frame assembly with one front leg 22 pivotally connected at a pivot P to a respective one of the rear legs 20 so as to permit folding of the frame assembly 12 as is also known in the art. FIG. 2 illustrates a side view of the stroller assembly shown in FIG. 1 and clearly depicts the various frame components on one side of the assembly 12.

In the disclosed example, the stroller assembly 10 also includes a handle assembly 30, which in this example is pivotally coupled to the upper ends of the rear legs 20 at the respective fold joints 18. The handle assembly 30 in the disclosed example generally includes a pair of laterally spaced apart push bars 32 extending upward and rearward from the respective fold joints 18. The handle assembly 30 is formed having a continuous U-shaped tube structure that includes the two push bars 32 a curved connecting section 34, which extends between the upper ends of the push bars 32. In the disclosed example, a stanchion assembly 36 extends upward and rearward from the connecting section 34 of the handle assembly 30. In the disclosed example the stanchion assembly 36 has a pair of connectors 38, which are laterally spaced apart from one another and project way from the connecting section 34. A latch actuator 40 is positioned between the connectors 38. A handle bar 42 or handle is coupled to the distal ends of the connectors 38 coincident with the actuator 40.

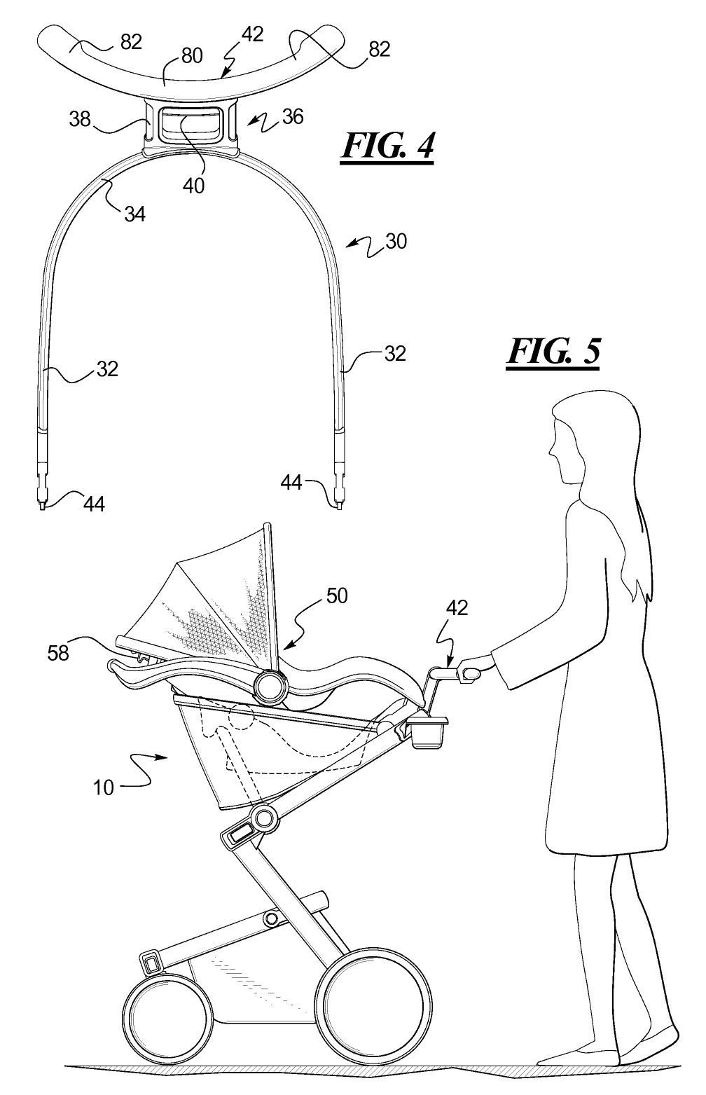

In general, the actuator 40 can be pulled by a user inward toward the handle bar or handle 42. This movement of the actuator 40 will in turn release latches (see FIG. 4) at the respective fold joints 18 as is known in the art. In one example, cables (not shown) can extend internally through the tubes of the connectors 38, connecting section 34, and push bars 32 in order to interconnect the actuator 40 with the latches 44 at each fold joint 18. Though not shown herein, when the actuator 40 is actuated and the fold joint latches 44 are released, the handle assembly 30 can be pivoted downward toward the rear legs 20. The front legs 22 will pivot about the pivot points P relative to the rear legs 20 as the rear legs drop downward. Thus, the frame assembly 12 can be folded to a folded configuration as is known in the art.

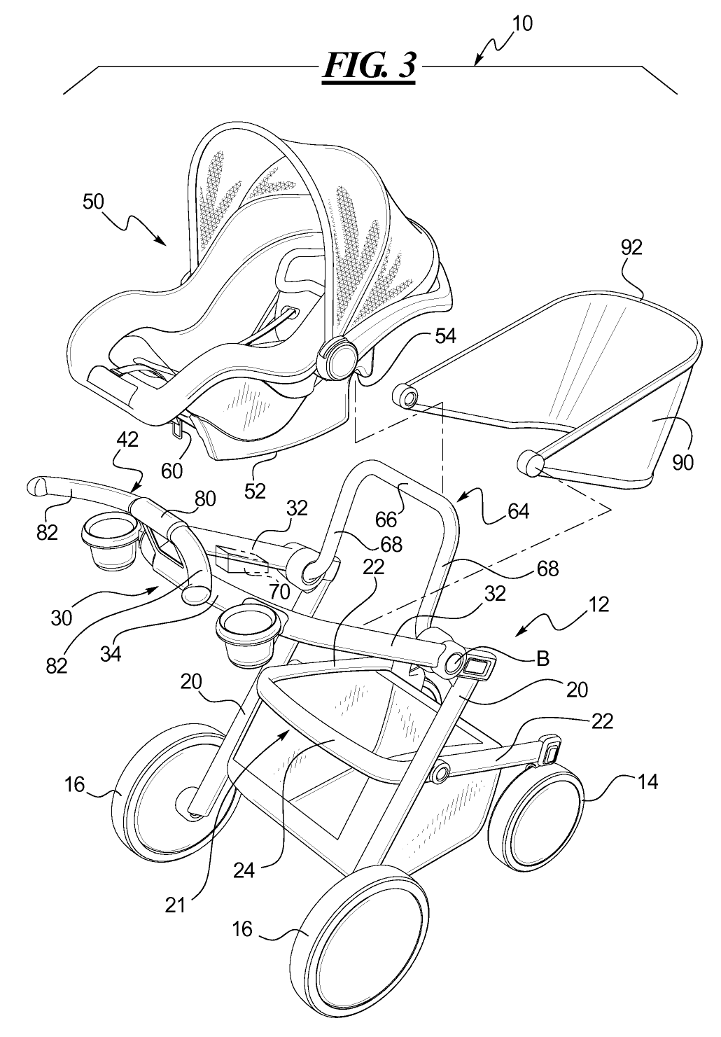

In the disclosed example, the frame assembly 12 can be provided with multiple mounting elements for interconnecting an infant carrier 50 to the frame assembly 12. Some of these mounting elements are active and require manual actuation to secure and/or release the element. Other of these mounting elements may typically require only passive engagement to a cooperating structure on the stroller. As shown in FIGS. 1-3, a typical infant carrier 50 in this example has a bottom 52 with one or more upward formed recesses 54 and a latch hook 56 on the bottom. A release handle or actuator 58 is typically provided on the carrier to move the latch hook 56 from a secured position to a release position. In this example, the latch hook 56, release handle 58, and recesses 54 are near the head or rear end of the carrier 50 and comprise an active mounting element on the carrier.

The typical carrier 50 also may have passive mounting points and structures on the bottom 52 at the other end, i.e., the foot or forward end of the carrier. These mounting elements are generically denoted at 60 in this example as being generally located near the forward end of the carrier 50. The mounting elements 60 can vary in location, structure, and form, but are typically configured to securely retain a connection between the infant carrier and a car seat base (not shown) when installed. The typical infant carrier, such as that shown as carrier 50 herein, comes with a car seat base that can be utilized to securely mount and install the carrier in a vehicle on the vehicle's seat. These same active and passive latching mechanisms and mounting points can also be utilized as generally shown in this example to mount the infant carrier 50 to the stroller assembly 10. The typical passive mounting element can be a pair of wire or steel loops 60 as shown herein.

In the disclosed example, the frame assembly 12 employs a pivotable brace 64 or support that can be pivoted between a stowed position (not shown) and a support position as shown for attaching the infant carrier 50 to the frame assembly 12. The brace 64 can be suitably secured or retained in each of the stowed and support positions using common mechanisms or other suitable devices, though also not shown or described herein. In this example, the brace 64 is generally U-shaped and has a cross member 66 extending between the upper free ends of a pair of laterally spaced arms 68. The lower ends of the arms 68 are pivotally connected to a portion of the frame assembly. In this example, the arms 68 are connected at pivot points B to the inside surfaces of the push arms 32 on the handle assembly 30. As shown in FIG. 2, the cross member 66 of the brace nests up into the recesses 54 of the conventional infant carrier 50 and the latch hook 56 underlies and catches the cross member. The actuator 58 can be utilized to release the latch hook 56 and thus the infant carrier 50 from the frame assembly 12 as is known in the art.

The brace 64 can take on a number of forms and configurations and yet fall within the spirit and scope of the present invention. For example, a toddler seat (not shown) of the stroller assembly 10 can include a seat back with a seat back frame that may define the brace 64 disclosed herein. In another example, the brace 64 can be a separate brace element positioned adjacent the toddler seat on the stroller assembly. In other examples, the brace 64 can be an arm bar or tray or work in conjunction with same. The brace can also be a removable adapter configured to mount on the frame assembly and to accept an infant carrier. The brace 64 or other like structures are intended to support the rear or head end of the infant carrier 50 when installed on the stroller assembly 10. The recesses 54 and latch hook 56 are typically disposed on the infant carrier, as in this example, near the rear end of the carrier. The brace or other structure need only configured to suitably engage these components on the carrier.

The forward or foot end of the carrier 50 typically employs the mounting elements 60. In one example, one or more mounting brackets 70 can be mounted on an interior side of each of the handle assembly push bars 32. The mounting brackets 70 are shown herein in only a generic fashion for simplicity. A single mounting bracket could alternatively be mounted to the connecting section 34 of the handle assembly 30 in this example. In another example, the mounting brackets 70 could alternatively be incorporated as part of a structure defining the pivot points B where the brace 64 attaches to the push arms in this example. In any event, the mounting brackets 70 can be configured to cooperate with the mounting elements 60 on the underside of the carrier 50 so as to rest on or be supported by the mounting brackets.

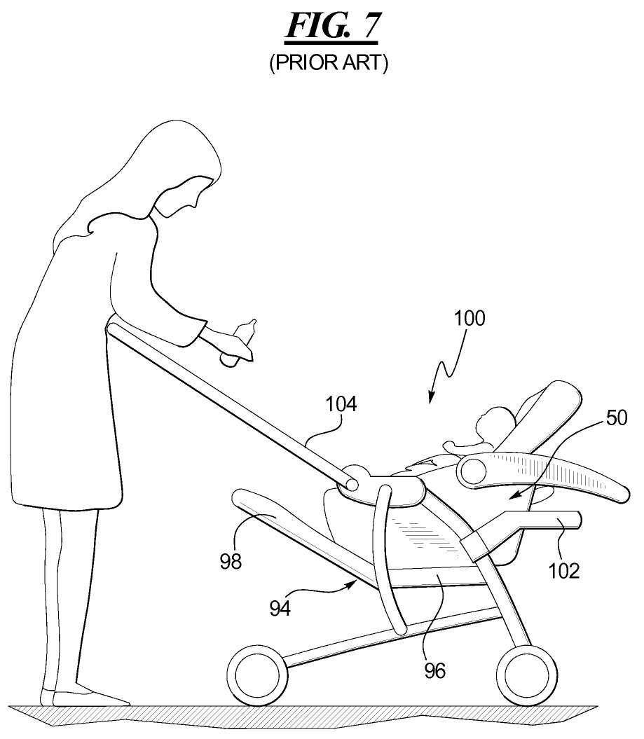

If desired, a separate latch, lock, or securing device can be employed to physically hold the carrier 50, and particularly the foot or forward end of the carrier, on the mounting brackets 70. In one example, though not shown herein, rotatable locks can be provided on the push arms directly adjacent the carrier sides and can rotate down onto the edges of the carrier to retain the carrier in place as is known in the art. The mounting arrangement disclosed herein for mounting the infant carrier 50 in an elevated or raised position as shown can vary within the spirit and scope of the present invention. The elevated carrier position, in comparison to the lower position known in the art and as discussed above (see FIG. 7), is intended to move the caregiver and child occupant closer to one another. Only one of many possible examples for achieving the elevated carrier position is disclosed and described herein.

The curved handle bar 42 will further improve upon meeting the intended purpose of permitting closer contact between child and caregiver during stroller usage. FIGS. 1 and 4 best illustrate the configuration of the handle bar or handle 42 disclosed herein. In this example, the handle bar 42 generally has a central section 80 that is coupled to the stanchion assembly 36 near the center of the frame assembly 12 between the frame sides. The handle bar 42 in this example also includes a pair of side sections 82 that extend in the opposite directions from the central section. Each of the side sections 82 in this example extends both laterally outward from the central section 80 and curves further rearward relative to the central section. In this example the handle bar 42 is generally C-shaped and has an arcuate or curved configuration. The curvature is arranged so that the handle bar is concave in the direction of the back of the frame assembly 12. This curvature positions the central section 80 closer to the front of the frame assembly 12 than the side sections 82. Though any part of the handle bar 42 may be grasped by the caregiver to push the stroller, a user will typically place their hands spaced apart on the stroller handle to improve stability and turning capability. Thus, the side sections 82 may define grips on the handle bar 42.

The intent of a conventional stroller handle is to place or position the caregiver far enough behind the stroller so that the caregiver can walk with a normal stride without kicking or hitting parts of the stroller with there feet. Thus, the grips of a typical stroller handle are positioned fairly far rearward relative to the stroller seat. As noted above, this arrangement positions the caregiver disadvantageously far from the seat occupant, and particularly from an occupant of an infant carrier mounted to the stroller. As shown in FIG. 5, the handle bar 42 of the disclosed example achieves the intent of most stroller handles in that in the side sections 82 create grips that are positioned far enough rearward relative to the back of the frame assembly to permit the caregiver to walk with a normal stride. However, the central section 80 of the handle bar 42 is positioned further forward relative to the side sections 82. Thus, an open space is created between the grips or side sections 82 of the handle bar 42.

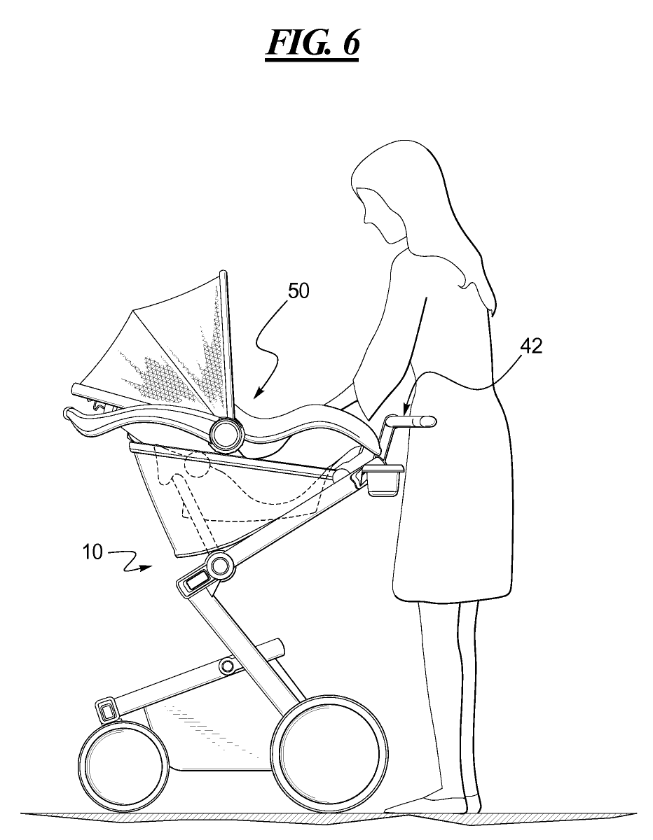

As shown in FIG. 6, the spacing between the side sections 82 on the disclosed handle bar 42 is sufficient to allow the caregiver to step forward between the grips or side sections 82 and stand closer to the stroller, if desired. As depicted, the caregiver can step forward between the side sections 82 of the handle bar 42 and can easily reach the infant carrier occupant. The caregiver can continue to operate the stroller while stepping forward into the open space in the handle bar 42, while watching there step. Alternately, the caregiver can stop the stroller and step into the open space against the central section 80 between the grips or side sections 82.

In combination, the disclosed handle bar 42 and the elevated or raised position of the infant carrier 50 on the frame assembly 12 create a number of advantages not found in prior art strollers. First, the infant carrier 50 can be mounted in a rear facing orientation so that the caregiver can see the child and, thus, monitor the child's behavior, mood, and condition. Also, the close spacing allows the child to more easily see the caregiver, both while the stroller is being pushed and when the stroller has been stopped. In addition, the elevated position of the infant carrier 50 brings the infant closer to the caregiver. Further, the concave curvature of the handle bar 42 allows the caregiver to step yet closer to the infant, if desired. Still further, the disclosed stroller assembly 10 allows the caregiver to stand behind the handle bar 42 and yet interact closely with an infant in the infant carrier 50. Further still, the caregiver can stand in a natural position (see FIG. 6) to reach out and touch the infant instead of perhaps trying to awkwardly bend over the top of the handle (see FIG. 7). The caregiver is thus more comfortable and less likely to injure their back. The caregiver also need not stop the stroller, apply the stroller break, step around the side of the stroller assembly, and bend over or lean downward toward the infant in order for the infant to make adequate eye contact and for the caregiver to interact with the infant.

It is well known that an ordinary infant cannot see very clearly beyond about 12 to 18 inches at a young age, as noted above. Therefore, a conventional stroller may hinder or even prevent an infant from being able to recognize the caregiver while the caregiver is pushing a stroller or while the caregiver stands behind the stroller handle. The disclosed arrangement of infant carrier and handle bar help to significantly reduce the distance between caregiver and infant. This greatly enhances or increases the likelihood that an infant will be able to clearly recognize the caregiver while the stroller is being utilized. This can be quite soothing and comforting to an infant.

As will be evident to those having ordinary skill in the art upon reading this disclosure, the handle bar 42 as disclosed herein can vary in configuration and yet achieve the intended advantages and benefits. In one example, the side sections 82 or gripping regions of the handle need not be formed as a continuous part along with the central section 80 as a C-shaped structure. Other shapes can be provided or created that allow a caregiver to step between gripping portions into an open space of the handle, and thus forward and closer to an infant held in a seat on the stroller. In addition, the side sections 82 or gripping portions need not be integrally formed as a part of the central section. The side sections could, alternatively be provide as attached to or integrally formed as part of another portion of the frame assembly, handle assembly, or the like. Alternate configurations and constructions are certainly within the purview of the present invention.

Compared to a standard straight or outwardly arched handle, the reverse arc of the handle shown and described herein allows the parent to step in closer to the child, and yet to stand clear of the back of the stroller to push the stroller while walking. This flexibility allows the parent to more easily reach, touch, and make eye contact with the child, but also allows improved kick space and maneuverability while walking.

Instead of utilizing the brace 64, which is provided as a pivotable part of the stroller, a removable adapter may be provided to support the rear of the infant carrier 50 and allow it to lock into place. The adapter may be removable to either expose a larger toddler seat on the stroller or to allow attachment of a removable toddler seat to the frame assembly. The removable toddler seat may even be attachable to the frame assembly at the same attachment points as the adapter.

Though generally not depicted herein, the stroller assembly 10 can be configured to also incorporate common, optional features such as wheel suspension, accessory and article storage, cup holders, parent or child trays, a canopy, and the like. In this example, an optional shroud 90 wraps around the perimeter of the infant carrier 50 beneath the seating surface when installed on the stroller 10. The shroud 90 is supported by a U-shaped wire or frame structure 92 that is pivotally coupled to the frame assembly 12. The shroud 90 is optional and can be configured to mask the support structure, such as the brace 64, beneath the infant carrier. Also, a variety of alternate structures and ways can be employed for mounting the infant carrier 50 in the raised or elevated position. Other alternatives may include using a pneumatic-type cylinder or spring biased device to allow height-adjustability of the infant carrier 50 while mounted to the stroller 10.

The handle assembly 30 can also vary from that shown and described herein. For example, the handle bar 42 can be attached directly to the connecting section 34, eliminating the stanchion assembly. In another example, the curved handle bar can be configured similar to a conventional handle with the handle bar section integrally connected to the ends of the pair of push bars. The handle bar in such an example can be curved concavely between the push bar ends in accordance with the teachings of the present invention. Also, the shape of the handle bar 42 can be more complex than the simple C-shaped configuration shown herein, while still achieving the intent of the invention. The C-shape can also be more or less pronounced from that depicted in the drawings. In another example, supplemental handles may be positioned at either side of the foot of the infant carrier 50 to allow the parent to envelop the child while braced against the central section of the handle bar and pushing the stroller.

Also as noted above, the frame assembly 12 can vary in configuration and construction and yet achieve the advantages and benefits disclosed and describe herein. The arrangement of front and rear legs, joints, and handle assembly components can be reconfigured within the spirit and scope of the present invention.

Though not shown herein, except in phantom view in FIG. 2 for ease of depicting aspects of the present invention, the stroller assembly 10 would have a forward facing toddler seat 94 disposed between the frame sides and forward of the handle bar 42. The typical toddler seat 94 has a seat back 96 and a seat bottom 98. As noted above, the brace 64 could be configured as the top frame part of the seat back 98. In such an example, the infant carrier could be supported on the top edge of the seat back 98, instead of a separate and distinct brace, when installed. The handle bar 42 would still provide substantial benefit, even if used without the infant carrier 50 as described herein. The handle bar 42 would still allow a caregiver to stand closer to the toddler seat, and thus the seat occupant, during use. The caregiver would be able to closely interact with and touch the toddler seat occupant without having to stop the stroller and step around to the side of the stroller and bend down in order to do so.

As disclosed herein, the infant carrier is positioned so as to place a child occupant of the infant carrier's seat at about the elevation of the handle. This is significantly above the elevation of an infant carrier mounting position of the prior art. A prior art stroller assembly has a stroller 100 generically depicted in FIG. 7 as including a tray 102 positioned in front of a toddler seat 94. The toddler seat 94 has a seat bottom 96 and a seat back 98 in a reclined position. The infant carrier 50 is supported in part on the tray 102 and in part on the reclined seat back 98, which places the carrier at a relatively low elevation. The combination of the low elevation and standard handle configuration places the caregiver at a lengthy distance behind the carrier and creates a barrier that ergonomically makes it difficult to interact with or touch the infant while using the stroller. The disclosed handle, as well as the disclosed elevated carrier position, makes it much easier for the caregiver to reach the child from behind the handle. In addition, the typical stroller handle extends upward and rearward behind the stroller. The further up the handle that the infant carrier can be mounted, the further rearward, and thus closer to the handle bar 42, the carrier is positioned. This also reduces the distance between caregiver and child.

The prior art handle and carrier positioning makes it difficult for a caregiver to reach an infant seated in the carrier. As a result of this distance, it can also be quite difficult for the child in the carrier 24 to recognize the caregiver. A young infant typically can not see clearly beyond about 12 to 18 inches, as previously noted. This lack of recognition can be disconcerting to a young infant. It is well known that direct eye contact between an infant and caregiver can be calming, comforting, and soothing to the infant. Direct eye contact between caregiver and infant at distances significantly greater than 18 inches would not be very beneficial or helpful. Also as noted above, direct physical contact between caregiver and infant can often prove very beneficial or even necessary for the wellbeing of the infant. While pushing the stroller, the caregiver may simply wish to reach out and touch the infant to calm or comfort the child. The caregiver may need to reposition the sleeping infant in the seat or replace a sock or hat. Any number of circumstances may frequently arise during stroller usage where the caregiver wishes or needs to quickly reach or touch the infant. Prior art stroller systems can significantly inhibit such contact.

Although certain stroller assemblies and stroller handles have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A stroller comprising:
a frame assembly having a front and a back; and
a handle coupled to the frame assembly and positioned near the back of the frame assembly, the handle having a central section between a pair of side sections, the side sections extending further rearward than the central section relative to the back of the frame assembly.

2. A stroller according to claim 1, further comprising a seat supported by the frame assembly, the seat positioned forward of the handle.

3. A stroller according to claim 2, wherein the seat is positioned on the stroller so that an occupant of the seat is positioned at about the same elevation as the handle on the stroller.

4. A stroller according to claim 2, wherein the seat is provided as part of an infant carrier removably coupled to the frame assembly forward of the handle.

5. A stroller according to claim 4, wherein the infant carrier is removably mounted to the stroller forward of the handle.

6. A stroller according to claim 4, wherein the seat is positioned on the stroller so that an occupant of the seat is positioned at about the same elevation as the handle on the stroller.

7. A stroller according to claim 1, wherein the handle is generally C-shaped and concave in the direction of the back of the frame assembly and wherein the side sections are spaced sufficiently apart to permit a caregiver to stand against the central section within an open region between the side sections.

8. A stroller according to claim 1, wherein the central section and side sections of the handle are integrally formed as one component with a curved profile.

9. A stroller according to claim 1, wherein the central section of the handle is connected to a handle assembly pivotally coupled to the frame assembly and the side sections are cantilevered from the central section, each terminating at a free end.

10. A stroller comprising:
a frame assembly having a front, a back, and left and right sides;
a toddler seat supported by the frame assembly between the left and right sides, the toddler seat having a seat back and a seat bottom and defining a forward facing direction toward the front of the frame assembly;
a handle assembly coupled to the frame assembly and having an upper end positioned rearward of the toddler seat; and
a handle bar on the upper end of the handle assembly positioned rearward of the toddler seat,
wherein the handle bar has a curved profile that is concave in the direction of the back of the frame assembly forming a central section and a pair of spaced apart side sections.

11. A stroller according to claim 10, wherein the handle bar is C-shaped.

12. A stroller according to claim 10, further comprising:
an infant carrier removably mounted to the frame assembly above the toddler seat, the infant carrier positioned to place an occupant of the infant carrier at about the elevation of the handle bar.

13. A stroller according to claim 12, wherein the infant carrier is supported in part on a brace extending from the frame assembly.

14. A stroller according to claim 13, wherein the brace is a top edge of the toddler seat back.

15. A stroller comprising:
a frame assembly supported by a plurality of wheels, the frame assembly having a front, a back, and left and right sides;
a handle assembly coupled to the frame assembly and having an upper end extending upward and toward the back of the frame assembly; and
a handle bar on the upper end of the push bar assembly, the handle bar having an arcuate shape that is concave toward the back of the stroller and having a central section connected to the push bar assembly and a pair of opposed side sections cantilevered from the central section, the central section positioned closer to the front of the frame assembly than the side sections.

16. A stroller according to claim 15, further comprising an infant carrier removably mounted to the frame assembly near the upper end of the handle assembly so as to place an occupant of the infant carrier at about the same elevation as the handle bar.

17. A stroller according to claim 16, wherein the infant carrier is supported in part by a brace pivotally connected to the frame assembly.

18. A stroller according to claim 15, further comprising a toddler seat supported by the frame assembly between the left and right sides and positioned forward of the handle bar.

19. A stroller according to claim 18, further comprising an infant carrier mounted in part to the seat back of the toddler seat and in part to the handle assembly, the infant carrier having a seat facing direction oriented toward the back of the frame assembly.

20. A stroller according to claim 15, wherein the handle bar is C-shaped with an open space between the side sections.
